(19) United States
(12) Patent Application Publication
(10) Pub. No.: US 2026/0328991 A1
(43) Pub. Date: Oct. 22, 2026

(54) MULTI-CORE OPTICAL AMPLIFYING FIBER AND OPTICAL AMPLIFIER

(71) Applicant: LIGHTERA JAPAN CO., LTD., Tokyo (JP)

(72) Inventors: Shigehiro TAKASAKA, Tokyo (JP); Koichi MAEDA, Tokyo (JP); Masanori TAKAHASHI, Tokyo (JP); Ryuichi SUGIZAKI, Tokyo (JP)

(73) Assignee: LIGHTERA JAPAN CO., LTD., Tokyo (JP)

(21) Appl. No.: 19/564,473

(22) Filed: Mar. 12, 2026

Related U.S. Application Data
(63) Continuation of application No. PCT/JP2024/033347, filed on Sep. 18, 2024.

(30) Foreign Application Priority Data
Sep. 21, 2023 (JP) 2023-154187

(51) Int. Cl. G02B 6/02; H04B 10/291

(52) U.S. Cl. CPC G02B 6/02042; G02B 6/02004; H04B 10/2912

(57) ABSTRACT

A multi-core optical amplifying fiber includes: a plurality of core portions doped with a rare earth element; an inner cladding portion surrounding the plurality of core portions and having a refractive index lower than a maximum refractive index of each of the core portions; and an outer cladding portion surrounding the inner cladding portion and having a refractive index lower than the refractive index of the inner cladding portion. The plurality of core portions include a first core portion at a first distance that is a distance from a central axis of the inner cladding portion extending along a longitudinal direction, and a second core portion at a second distance that is a distance from the central axis and longer than the first distance.

This application is a continuation of International Application No. PCT/JP2024/033347, filed on September 18, 2024 which claims the benefit of priority of the prior Japanese Patent Application No. 2023-154187, filed on September 21, 2023, the entire contents of which are incorporated herein by reference.

### BACKGROUND

The present disclosure relates to multi-core optical amplifying fibers and optical amplifiers.

### Background

Using multi-core erbium-doped optical fiber amplifiers (EDFAs) as optical amplifiers for uses in, for example, submarine optical communication, is hoped to reduce power consumption of the optical amplifiers.

In configurations known as multi-core EDFAs, a double-cladding multi-core EDF is used and erbium (Er), which is an optical amplifying medium included in core portions, is optically pumped by a cladding pumping scheme (see Kazi S Abedin et al., "Multimode Erbium Doped Fiber Amplifiers for Space Division Multiplexing Systems", JOURNAL OF LIGHTWAVE TECHNOLOGY, Vol. 32, No. 16, August 15, 2014, pp. 2800 to 2808, and Kazi S Abedin et al., "Cladding-pumped erbium-doped multi-core fiber amplifier", OPTICS EXPRESS, Vol. 20, No. 18, 27 August 2012, pp. 20191 to 20200). A multi-core EDF is a type of multi-core optical amplifying fiber.

### SUMMARY

In multi-core EDFAs, signal light is individually input to a plurality of core portions respectively and amplified. In this case, differences in gain applied to the signal light between the core portions are preferably small. This is because large differences in gain between the core portions cause power variations among the signal light and thus also variations in signal transmission distance and signal transmission quality.

There is a need for a multi-core optical amplifying fiber that enables reduction of differences in gain between a plurality of core portions, and an optical amplifier using the multi-core optical amplifying fiber.

According to one aspect of the present disclosure, there is provided a multi-core optical amplifying fiber including: a plurality of core portions doped with a rare earth element; an inner cladding portion surrounding the plurality of core portions and having a refractive index lower than a maximum refractive index of each of the core portions; and an outer cladding portion surrounding the inner cladding portion and having a refractive index lower than the refractive index of the inner cladding portion, wherein the plurality of core portions include a first core portion at a first distance that is a distance from a central axis of the inner cladding portion extending along a longitudinal direction, and a second core portion at a second distance that is a distance from the central axis and longer than the first distance, and in a case where pumping light that optically pumps the rare earth element and has predetermined power is caused to propagate through the inner cladding portion and signal light that is optically amplified by the rare earth element is caused to propagate through each of the first core portion and the second core portion, a difference between a first gain obtained by the signal light in the first core portion and a second gain obtained by the signal light in the second core portion is less than 0.9 dB.

### BRIEF DESCRIPTION OF THE DRAWINGS

FIG. 1 is a schematic sectional view of a multi-core optical amplifying fiber according to a first embodiment;

FIG. 2 is a schematic diagram illustrating a refractive index profile of the multi-core optical amplifying fiber illustrated in FIG. 1;

FIG. 3 is a schematic sectional view of a multi-core optical amplifying fiber according to a second embodiment;

FIG. 4 is a schematic diagram illustrating a refractive index profile of the multi-core optical amplifying fiber illustrated in FIG. 3;

FIG. 5 is a schematic sectional view of a multi-core optical amplifying fiber according to a third embodiment;

FIG. 6 is a schematic diagram illustrating a refractive index profile of the multi-core optical amplifying fiber illustrated in FIG. 5;

FIG. 7 is a schematic sectional view of a multi-core optical amplifying fiber according to a fourth embodiment;

FIG. 8 is a schematic sectional view of an optical amplifier according to a fifth embodiment;

FIG. 9 is a schematic sectional view of a multi-core optical amplifying fiber according to a sixth embodiment;

FIG. 10 is a schematic sectional view of a multi-core optical amplifying fiber according to a seventh embodiment;

FIG. 11 is a schematic sectional view of a multi-core optical amplifying fiber according to an eighth embodiment;

FIG. 12 is a schematic sectional view of a multi-core optical amplifying fiber according to a ninth embodiment; and

FIG. 13 is a schematic sectional view of a multi-core optical amplifying fiber according to a tenth embodiment.

### DETAILED DESCRIPTION

Embodiments will be described hereinafter by reference to the drawings. The present disclosure is not to be limited by these embodiments. Furthermore, the same reference sign will be assigned to elements that are the same or corresponding to each other throughout the drawings as appropriate, and redundant description thereof will be omitted as appropriate. It also needs to be noted that the drawings are schematic, and relations among dimensions of each element and ratios among elements, for example, may be different from the actual relations and ratios. A portion having different dimensional relations and ratios among the drawings may also be included. Furthermore, in this specification, a cutoff wavelength means a cable cutoff wavelength defined by International Telecommunication Union (ITU-T) G.650.1. Furthermore, any other term not particularly defined in this specification conforms to the definition or measurement method according to G.650.1 and G.650.2.

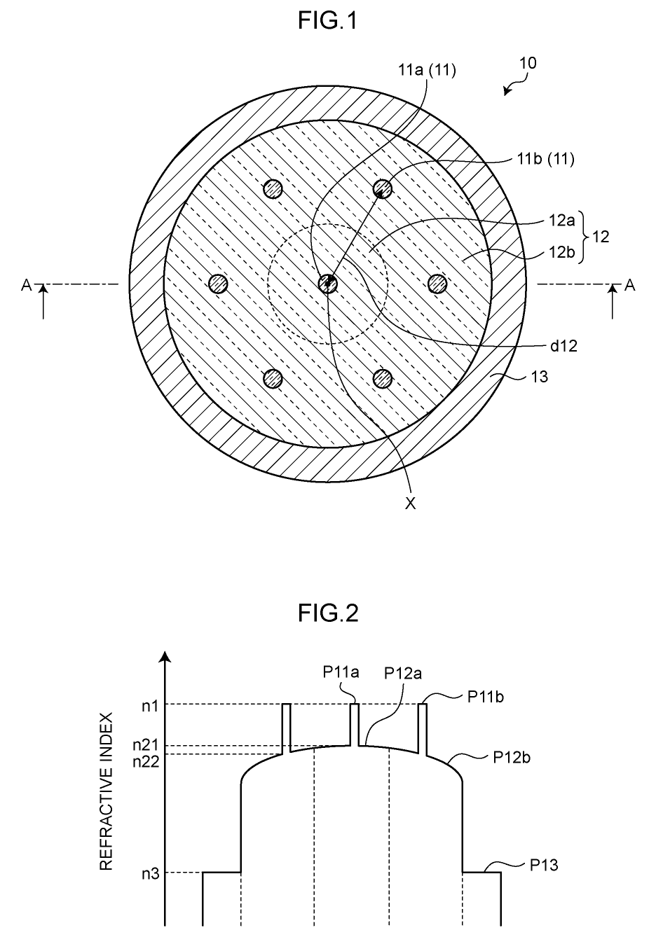

FIG. 1 is a schematic sectional view of a multi-core optical amplifying fiber according to a first embodiment and illustrates a cross section of the multi-core optical amplifying fiber, the cross section being perpendicular to a longitudinal direction of the multi-core optical amplifying fiber. A multi-core optical amplifying fiber 10 is a double-cladding seven-core multi-core optical fiber including seven core portions 11, an inner cladding portion 12 surrounding the core portions 11, and an outer cladding portion 13 surrounding the inner cladding portion 12. The core portions 11 are an example of a plurality of core portions.

The core portions 11 are made of glass, such as silica-based glass. The core portions 11 are arranged in a triangular lattice to be in a close-packed state. One core portion 11a of the core portions 11 is arranged such that its central axis coincides with a central axis X extending along the longitudinal direction in the inner cladding portion 12. The central axis X in the inner cladding portion 12 may be defined as the centroid of the inner cladding portion 12. Six core portions 11b of the core portions 11 are arranged to be at positions of the vertices of a regular hexagon around the central axis X. In this case, the core portions 11 are arranged to have n-fold rotational symmetry within the inner cladding portion, where n is 2, 3, or 6.

The core portions 11 include a refractive index adjusting dopant that increases their refractive index, for example, germanium (Ge) and/or aluminum (Al). The core portions 11 also include Er as a rare earth element, which is an amplifying medium. Er is doped, for example, at a concentration where the peak of the absorption coefficient near a wavelength of 1530 nm becomes 2.5 dB/m to 11 dB/m. Furthermore, for example, the doping concentration is 250 ppm to 2000 ppm. However, the absorption coefficient and the doping concentration are not particularly limited. Al also has a function of reducing concentration quenching of Er.

The inner cladding portion 12 is made of glass, such as silica-based glass. The inner cladding portion 12 has layered cladding portions 12a and 12b as a plurality of layered cladding portions that have been formed concentrically. The layered cladding portion 12a is a portion having a circular cross section with a central axis that is substantially the same as the central axis X. The layered cladding portion 12b is a portion having an annular cross section surrounding the outer periphery of the layered cladding portion 12a. The layered cladding portion 12a surrounds the core portion 11a, and the layered cladding portion 12b surrounds the core portions 11b. That is, one or more core portions of the core portions 11 is/are arranged in each of the layered cladding portions 12a and 12b.

The outer cladding portion 13 is made of resin, for example. The resin is publicly known resin used as resin cladding portions of double-cladding optical fibers, for example.

FIG. 2 is a schematic diagram illustrating a refractive index profile in a cross section of the multi-core optical amplifying fiber 10, the cross section being along a line A-A. In FIG. 2, profiles P11a and P11b respectively represent refractive index profiles of the core portions 11a and 11b. Profiles P12a and P12b respectively represent refractive index profiles of the layered cladding portions 12a and 12b of the inner cladding portion 12. A profile P13 represents a refractive index profile of the outer cladding portion 13.

As illustrated in FIG. 2, maximum refractive indices of the core portions 11 are all n1. Furthermore, the refractive index profiles of the core portions 11 are of the step index (SI) type or the graded index (GI) type. Furthermore, the inner cladding portion 12 has a refractive index lower than the maximum refractive index of each of the core portions 11. The inner cladding portion 12 has a refractive index profile of the GI type in which the refractive index is high at the central axis X and decreases toward the periphery in the radial direction. The glass forming the inner cladding portion 12 is distributedly doped with a dopant, for example, fluorine, so as to provide the refractive index profile of the GI type. As a result, a refractive index of the layered cladding portion 12a (central region) represented by the profile P12a is higher than a refractive index of the layered cladding portion 12b (peripheral region) represented by the profile P12b. Furthermore, a refractive index (an example of a first refractive index) n21 of the inner cladding portion 12 (layered cladding portion 12a) near the core portion 11a is higher than a refractive index (an example of a second refractive index) n22 of the inner cladding portion 12 (layered cladding portion 12b) near the core portions 11b. Being near a core portion means, for example, being in a range of about several micrometers separate from the outer edge of the core portion. Furthermore, the outer cladding portion 13 has a refractive index n3 lower than the refractive index of the inner cladding portion 12.

In this embodiment, the core portions 11a and 11b have a core Δ of, for example, 0.35% to 2% at a wavelength of 1550 nm, where the core Δ is a relative refractive-index difference between the maximum refractive index of the core portion 11a or 11b and that of the inner cladding portion 12. However, as illustrated in FIG. 2, in this embodiment, the core Δ of the core portions 11b is larger than the core Δ of the core portion 11a. In relation to the core Δ, a core diameter of each of the core portions 11a and 11b is preferably set to achieve a cutoff wavelength shorter than an optical amplification wavelength band where a rare earth element enables optical amplification. Each of the core portions 11a and 11b thereby enables propagation of signal light of the optical amplification wavelength band in a single mode. In the case of Er, the optical amplification wavelength band where a rare earth element enables optical amplification is, for example, 1530 nm to 1565 nm called the C band, or for example, 1565 nm to 1625 nm called the L band. A mode field diameter of each of the core portions 11a and 11b at a wavelength at which Er provides optical amplification, for example, 1550 nm, is, for example, 5 µm or more and 11 µm or less.

A distance to the single core portion 11a, which is a first core portion, of the core portions 11, from the central axis X of the inner cladding portion 12 (that is, a distance from the central axis X to the central axis of the core portion 11a) is a first distance d11. The first distance d11 is zero, as described above. Distances to the six core portions 11b, which are second core portions, on the other hand, from the central axis X of the inner cladding portion 12 are second distances d12. The distances to the core portions 11b from the central axis X are approximately equal. The second distances d12 are equal to the inter-core distance in the core portions 11 and are, for example, 38.5 µm.

To examine gain characteristics for each core portion of a multi-core optical amplifying fiber, the inventors fabricated a test multi-core optical amplifying fiber that is a double-cladding and seven-core multi-core optical amplifying fiber like the multi-core optical amplifying fiber 10 and has an inner cladding portion with a uniform refractive index from its central axis in the radial direction. Pumping light having predetermined power to optically pump a rare earth element (for example, having a wavelength of 975 nm and power of 17 W) was caused to propagate through the inner cladding, and signal light optically amplified by the rare earth element (for example, having a wavelength of 1550 nm and -5.0 dBm) was caused to propagate through each of the core portions. A gain obtained by the signal light in the core portion near the central axis of the inner cladding was then found to be lower than a gain obtained by the signal in the core portions far from the central axis of the inner cladding (that is, the gain difference became large).

In contrast, in the multi-core optical amplifying fiber 10, the inner cladding portion 12 has a refractive index profile of the GI-type such that the refractive index is high at the central axis X and near the central axis X and decreases toward the periphery in the radial direction. As compared with the test multi-core optical amplifying fiber, pumping light propagating through the inner cladding portion 12 is thereby distributed such that its power density becomes higher nearer to the central axis X. As a result, the difference between a gain (an example of a first gain) in the core portion 11a nearer to the central axis X and a gain (an example of a second gain) in the core portions 11b farther from the central axis X becomes small.

Furthermore, in the multi-core optical amplifying fiber 10, the core portion 11a nearer to the central axis X has a smaller relative refractive-index difference with respect to the inner cladding portion 12 than the core portions 11b. As a result, the core portion 11a has a larger mode field diameter than the core portions 11b. As a result, the gain difference between the gain in the core portion 11a and the gain in the core portions 11b becomes small also due to the effect of the mode field diameter difference.

As described above, the multi-core optical amplifying fiber 10 according to the first embodiment enables reduction in the difference between the first gain and the second gain. For example, the difference is less than 0.9 dB in a case where the pumping light has a wavelength of 975 nm and power of 17 W, the signal light has a wavelength of 1550 nm and -5.0 dBm, and a gain of 18 dB is set to be obtained in each core portion. However, the gain difference is more preferably 0.5 dB or less and even more preferably 0.3 dB or less.

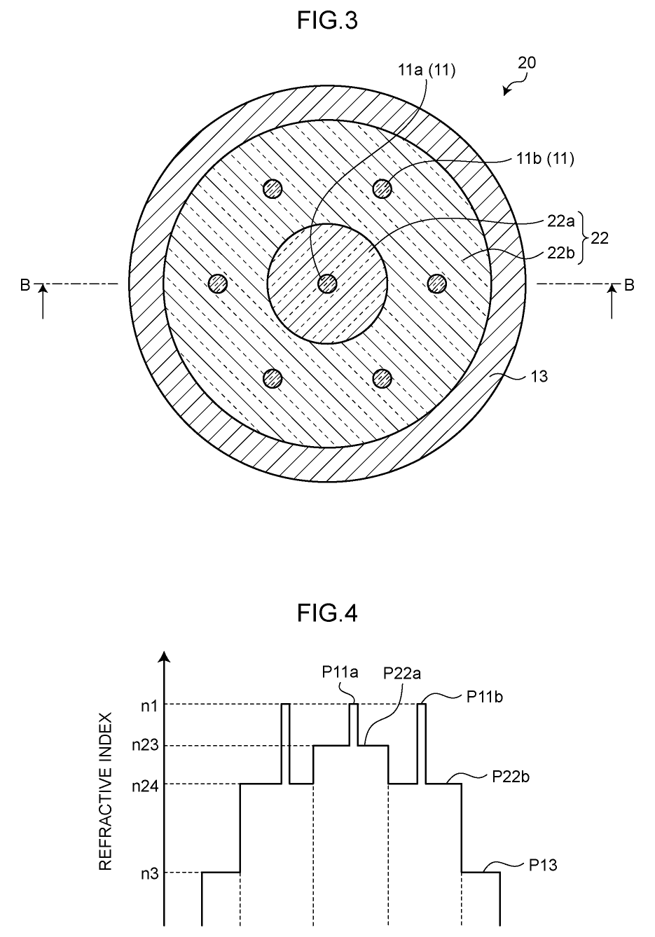

FIG. 3 is a schematic sectional view of a multi-core optical amplifying fiber according to a second embodiment and illustrates a cross section of the multi-core optical amplifying fiber, the cross section being perpendicular to a longitudinal direction of the multi-core optical amplifying fiber. A multi-core optical amplifying fiber 20 is a double-cladding seven-core multi-core optical fiber having a configuration of the multi-core optical amplifying fiber 10 illustrated in FIG. 1, with the inner cladding portion 12 replaced by an inner cladding portion 22.

The inner cladding portion 22 is made of glass, such as silica-based glass. The inner cladding portion 22 has layered cladding portions 22a and 22b as a plurality of layered cladding portions that have been formed concentrically. The layered cladding portion 22a is a portion having a circular cross section with a central axis that is substantially the same as the central axis X. The layered cladding portion 22b is a portion having an annular cross section surrounding the outer periphery of the layered cladding portion 22a. The layered cladding portion 22a surrounds the core portion 11a, and the layered cladding portion 22b surrounds the core portions 11b. That is, one or more core portions of the core portions 11 is/are arranged in each of the layered cladding portions 22a and 22b.

FIG. 4 is a schematic diagram illustrating a refractive index profile in a cross section of the multi-core optical amplifying fiber 20, the cross section being along a line B-B. In FIG. 4, profiles P22a and P22b respectively represent refractive index profiles of the layered cladding portions 22a and 22b of the inner cladding portion 22.

As illustrated in FIG. 4, the inner cladding portion 22 has a refractive index lower than the maximum refractive index of each of the core portions 11. The inner cladding portion 22 has a stepped refractive index profile in which the layered cladding portion 22a including the central axis X has a refractive index of n23 that is approximately uniform and comparatively high and the layered cladding portion 22b has a refractive index of n24 that is approximately uniform and comparatively low. In this case, the layered cladding portion 22a is made of, for example, pure silica glass. The layered cladding portion 22b is made of, for example, silica glass doped with a dopant, such as fluorine, so as to have the stepped refractive index profile. The layered cladding portion 22b has a relative refractive-index difference of, for example, -1.2% or more and -0.7% or less with respect to the layered cladding portion 22a. As a result, the refractive index of the layered cladding portion 22a (central region) is higher than the refractive index of the layered cladding portion 22b (peripheral region). Furthermore, the refractive index (an example of a first refractive index) n23 of the inner cladding portion 22 (layered cladding portion 22a) near the core portion 11a is higher than the refractive index (an example of a second refractive index) n24 of the inner cladding portion 22 (layered cladding portion 22b) near the core portions 11b.

The core portion 11a or core portions 11b also has/have a core Δ of, for example, 0.35% to 2% at a wavelength of 1550 nm with respect to the inner cladding portion 22.

Furthermore, in the multi-core optical amplifying fiber 20 also, the distance to the core portion 11a from the central axis X is the first distance d11 and is zero as described above. The distance to the core portions 11b from the central axis X on the other hand is the second distance d12 and is, for example, 38.5 µm.

As described above, the multi-core optical amplifying fiber 20 has the stepped refractive-index profile such that in the inner cladding portion 22, the refractive index of the central region including the central axis X is high and the refractive index of the peripheral region in the radial direction is low. In this case also, as compared with the test multi-core optical amplifying fiber, pumping light propagating through the inner cladding portion 22 is distributed such that its power density becomes higher nearer to the central axis X. As a result, the difference between the gain in the core portion 11a nearer to the central axis X and the gain in the core portions 11b farther from the central axis X becomes small.

Furthermore, in the multi-core optical amplifying fiber 20 also, the core portion 11a nearer to the central axis X has a larger mode field diameter than the core portions 11b. As a result, the gain difference between the gain in the core portion 11a and the gain in the core portions 11b becomes small due to the effect of the mode field diameter difference.

As described above, the multi-core optical amplifying fiber 20 according to the second embodiment enables reduction in the difference between the first gain and the second gain. For example, the difference is less than 0.9 dB in a case where the pumping light has a wavelength of 975 nm and power of 17 W, the signal light has a wavelength of 1550 nm and -5.0 dBm, and a gain of 18 dB is set to be obtained in each core portion. However, the gain difference is more preferably 0.5 dB or less and even more preferably 0.3 dB or less.

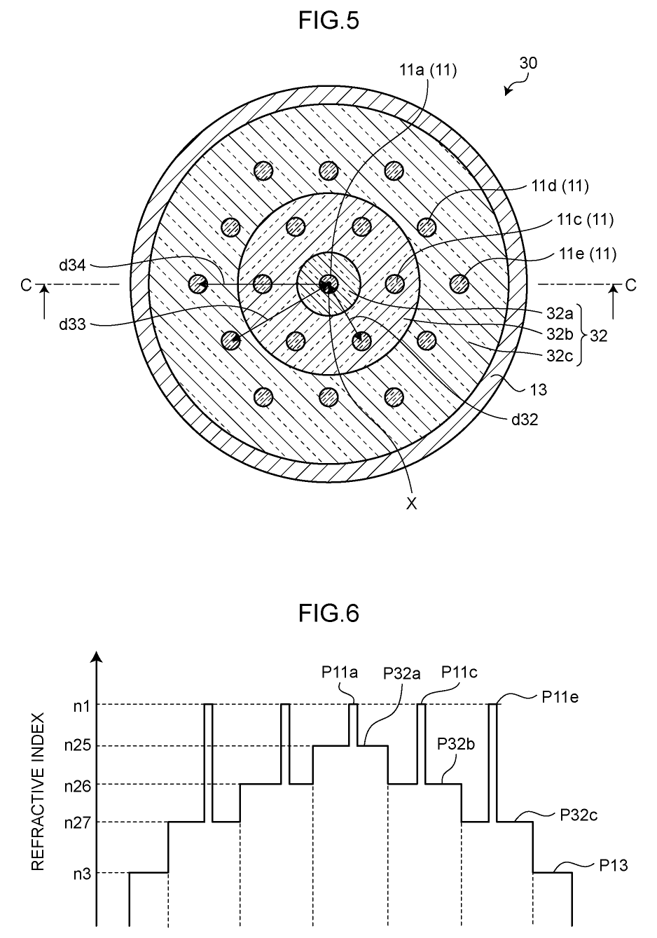

FIG. 5 is a schematic sectional view of a multi-core optical amplifying fiber according to a third embodiment and illustrates a cross section of the multi-core optical amplifying fiber, the cross section being perpendicular to a longitudinal direction of the multi-core optical amplifying fiber. A multi-core optical amplifying fiber 30 is a double-cladding 19-core multi-core optical fiber having a configuration of the multi-core optical amplifying fiber 20 illustrated in FIG. 3 with the number of core portions 11 changed to 19 and the inner cladding portion 22 replaced by an inner cladding portion 32.

The core portions 11 are arranged in a triangular lattice to be in a close-packed state. One core portion 11a of the core portions 11 is arranged such that its central axis coincides with a central axis X extending along a longitudinal direction in the inner cladding portion 32. Six core portions 11c of the core portions 11 are arranged to be at positions of the vertices of a regular hexagon around the central axis X. Six core portions 11d of the core portions 11 are arranged to be at positions of the vertices of a regular hexagon around the central axis X. Six core portions 11e of the core portions 11 are arranged to be at positions of the vertices of a regular hexagon around the central axis X.

The inner cladding portion 32 is made of glass, such as silica-based glass. The inner cladding portion 32 has layered cladding portions 32a, 32b, and 32c as a plurality of layered cladding portions that have been formed concentrically. The layered cladding portion 32a is a portion having a circular cross section with a central axis that is substantially the same as the central axis X. The layered cladding portion 32b is a portion having an annular cross section surrounding the outer periphery of the layered cladding portion 32a. The layered cladding portion 32c is a portion having an annular cross section surrounding the outer periphery of the layered cladding portion 32b. The layered cladding portion 32a surrounds the core portion 11a, the layered cladding portion 32b surrounds the core portions 11c, and the layered cladding portion 32c surrounds the core portions 11d and 11e. That is, one or more core portions of the core portions 11 is/are arranged in each of the layered cladding portions 32a, 32b, and 32c.

FIG. 6 is a schematic diagram illustrating a refractive index profile in a cross section of the multi-core optical amplifying fiber 30, the cross section being along a line C-C. In FIG. 6, profiles P11a, P11c, and P11e respectively represent refractive index profiles of the core portions 11a, 11c, and 11e. Profiles P32a, P32b, and P32c respectively represent refractive index profiles of the layered cladding portions 32a, 32b, and 32c of the inner cladding portion 32.

As illustrated in FIG. 6, maximum refractive indices of the core portions 11 are all n1. Furthermore, the inner cladding portion 32 has a refractive index lower than the maximum refractive index of each of the core portions 11. The inner cladding portion 32 has a stepped refractive index profile in which the layered cladding portion 32a including the central axis X has a refractive index of n25 that is approximately uniform and comparatively high, the layered cladding portion 32b has a refractive index of n26 that is approximately uniform and lower than n25, and the layered cladding portion 32c has a refractive index of n27 that is approximately uniform and even lower than n26. In this case, the layered cladding portion 32a is made of, for example, pure silica glass. The layered cladding portions 32b and 32c are made of, for example, silica glass doped with a dopant, such as fluorine, so as to have the stepped refractive index profile. The layered cladding portion 32c has a relative refractive-index difference of, for example, -1.2% or more and -0.7% or less with respect to the layered cladding portion 32a. As a result, the refractive index of the layered cladding portion 32a (central region) is higher than the refractive indices of the layered cladding portions 32b and 32c (peripheral regions). Furthermore, the refractive index (an example of a first refractive index) n25 of the inner cladding portion 32 (layered cladding portion 32a) near the core portion 11a is higher than the refractive index (an example of a second refractive index) n26 of the inner cladding portion 32 (layered cladding portion 32b) near the core portions 11b. Furthermore, the refractive index (an example of a first refractive index) n26 of the inner cladding portion 32 (layered cladding portion 32b) near the core portions 11b is higher than the refractive index (an example of a second refractive index) of the inner cladding portion 32 (layered cladding portion 32c) near the core portions 11c. Furthermore, the refractive index (an example of a first refractive index) n25 of the inner cladding portion 32 (layered cladding portion 32a) near the core portions 11a is higher than the refractive index (an example of a second refractive index) of the inner cladding portion 32 (layered cladding portion 32c) near the core portions 11c.

In the multi-core optical amplifying fiber 30 also, the single core portion 11a of the core portions 11 is at the distance of d11 from the central axis X of the inner cladding portion 32. As described above, d11 is zero. Furthermore, the six core portions 11c are at a distance of d32 from the central axis X of the inner cladding portion 32. The distances to the core portions 11c from the central axis X are approximately equal. Furthermore, the six core portions 11d are at a distance of d33 from the central axis X of the inner cladding portion 32. The distances to the core portions 11d from the central axis X are approximately equal. Furthermore, the six core portions 11e are at a distance of d34 from the central axis X of the inner cladding portion 32. The distances to the core portions 11e from the central axis X are approximately equal. This d32 is equal to the inter-core distance in the core portions 11 and is, for example, 38.5 µm. If any one of d11, d32 ,d33, and d34 is an example of a first distance, any distance thereof longer (farther) than the first distance is an example of a second distance in relation to the first distance.

As described above, in the multi-core optical amplifying fiber 30, the inner cladding portion 32 has the stepped refractive-index profile such that the refractive index of the central region including the central axis X becomes high and the refractive indices of the peripheral regions in the radial direction become low. In this case also, as compared with the test multi-core optical amplifying fiber, pumping light propagating through the inner cladding portion 32 is distributed such that its power density becomes higher nearer to the central axis X. As a result, the difference between a gain (an example of a first gain) in the core portion 11 (for example, the core portion 11a) nearer to the central axis X among the core portions 11 and a gain (an example of a second gain) in the core portion 11 (for example, the core portion 11c) farther from the central axis X becomes small. Furthermore, the difference between the gain (an example of a first gain) in the core portion 11 (for example, the core portion 11a) nearer to the central axis X among the core portions 11 and a gain (an example of a second gain) in the core portion 11 (for example, the core portion 11e) farther from the central axis X becomes small.

Furthermore, in the multi-core optical amplifying fiber 30 also, the core portion (for example, the core portion 11a) nearer to the central axis X has a larger mode field diameter than the core portions (for example, the core portions 11e) farther from the central axis X. As a result, the gain difference between the gain in the core portion 11a and the gain in the core portions 11e becomes small also due to the effect of the mode field diameter difference.

As described above, the multi-core optical amplifying fiber 30 according to the third embodiment enables reduction in the difference between the first gain and the second gain. For example, the difference is less than 0.9 dB in a case where the pumping light has a wavelength of 975 nm and power of 17 W, the signal light has a wavelength of 1550 nm and -5.0 dBm, and a gain of 18 dB is set to be obtained in each core portion. However, the gain difference is more preferably 0.5 dB or less and even more preferably 0.3 dB or less.

In this embodiment, the core portions 11c and 11e at different distances from the central axis X are arranged in the same layered cladding portion 32c, but the core portions 11c and the core portions 11e may be arranged in different layered cladding portions. In this case, the layered cladding portion of the core portions 11e at the longer distance from the central axis X may have a refractive index lower than a refractive index of the layered cladding portion of the core portions 11d at the shorter distance from the central axis X.

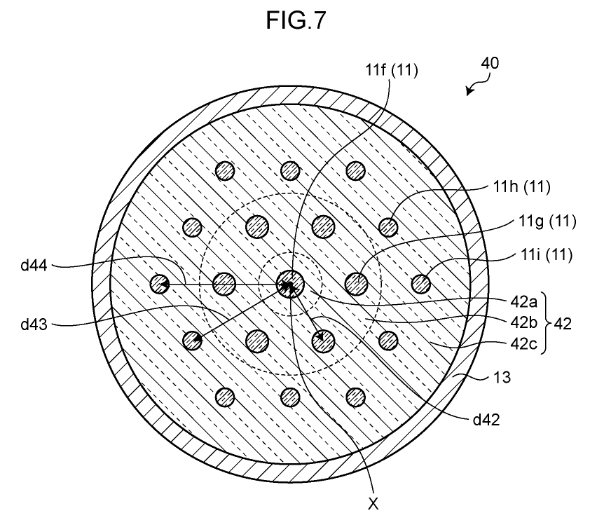

FIG. 7 is a schematic sectional view of a multi-core optical amplifying fiber according to a fourth embodiment and illustrates a cross section of the multi-core optical amplifying fiber, the cross section being perpendicular to a longitudinal direction of the multi-core optical amplifying fiber. A multi-core optical amplifying fiber 40 is a double-cladding 19-core multi-core optical fiber having a configuration of the multi-core optical amplifying fiber 10 illustrated in FIG. 1, with the number of core portions 11 changed to 19 and the inner cladding portion 12 replaced by an inner cladding portion 42.

The core portions 11 are arranged in a triangular lattice to be in a close-packed state. One core portion 11f of the core portions 11 is arranged such that its central axis coincides with the central axis X extending along the longitudinal direction in the inner cladding portion 42. Six core portions 11g of the core portions 11 are arranged to be at positions of the vertices of a regular hexagon around the central axis X. Six core portions 11h of the core portions 11 are arranged to be at positions of the vertices of a regular hexagon around the central axis X. Six core portions 11i of the core portions 11 are arranged to be at positions of the vertices of a regular hexagon around the central axis X.

In the multi-core optical amplifying fiber 40 also, the single core portion 11f of the core portions 11 is at a distance of d41 from the central axis X of the inner cladding portion 42. As described above, d41 is zero. The six core portions 11g on the other hand are at a distance of d42 from the central axis X of the inner cladding portion 42. The distances to the core portions 11g from the central axis X are approximately equal. Furthermore, the six core portions 11h are at a distance of d43 from the central axis X of the inner cladding portion 42. The distances to the core portions 11h from the central axis X are approximately equal. Furthermore, the six core portions 11i are at a distance of d44 from the central axis X of the inner cladding portion 42. The distances to the core portions 11i from the central axis X are approximately equal. This d42 is equal to the inter-core distance in the core portions 11 and is, for example, 38.5 µm. If any one of d11, d42 ,d43, and d44 is an example of a first distance, any distance thereof longer (farther) than the first distance is an example of a second distance in relation to the first distance.

Furthermore, the core portion 11f has the largest core diameter among the core portions 11 and also the largest mode field diameter at a wavelength of signal light. The six core portions 11g that are second core portions have the second largest core diameter among the core portions 11 and also the second largest mode field diameter at the wavelength of the signal light. The twelve core portions 11h and 11i have the third largest core diameter among the core portions 11 and also the third largest mode field diameter at the wavelength of the signal light. If any one of the core portions 11 is an example of a first core portion, the mode field diameter of that first core portion is a first mode field diameter. Furthermore, a core portion at a longer distance from the central axis X than the first core portion is an example of a second core portion, and the mode field diameter of this second core portion is an example of a second mode field diameter.

The inner cladding portion 42 is made of glass, such as silica-based glass. The inner cladding portion 42 has layered cladding portions 42a, 42b, and 42c as a plurality of layered cladding portions that have been formed concentrically. The layered cladding portion 42a is a portion having a circular cross section with a central axis that is substantially the same as the central axis X. The layered cladding portion 42b is a portion having an annular cross section surrounding the outer periphery of the layered cladding portion 42a. The layered cladding portion 42c is a portion having an annular cross section surrounding the outer periphery of the layered cladding portion 42b. The layered cladding portion 42a surrounds the core portion 11f, the layered cladding portion 42b surrounds the core portions 11g, and the layered cladding portion 42c surrounds the core portions 11h and 11i. That is, one or more core portions of the core portions 11 is/are arranged in each of the layered cladding portions 42a, 42b, and 42c.

In the inner cladding portion 42, the layered cladding portions 42a, 42b, and 42c have refractive indices that are equal and uniform.

As described above, in the test multi-core optical amplifying fiber having the inner cladding portion with a refractive index that is uniform from the central axis in the radial direction, the gain obtained by signal light in the core portion near the central axis of the inner cladding is lower than the gain obtained by signal light in the core portion far from the central axis of the inner cladding (that is, the gain difference becomes large).

However, in the multi-core optical amplifying fiber 40, the core portion 11f nearer to the central axis X has the largest mode field diameter, and the mode field diameter decreases as the distance from the central axis increases. As a result, the gain difference between the gain in the core portion 11f and the gain in the core portions 11i becomes small due to the effect of the mode field diameter difference. As a result, the difference between the gain (first gain) in the core portion 11f nearer to the central axis X and the gain (second gain) in, for example, the core portion 11g farther from the central axis X becomes small.

A mode field diameter at a wavelength of signal light of a core portion arranged in a first layered cladding portion of the plurality of layered cladding portions 42a, 42b, and 42c may be larger than a mode field diameter at the wavelength of the signal light of a core portion arranged in a second layered cladding portion outside and adjacent to the first layered cladding portion, by 10% or more and 20% or less. That is, for example, if the layered cladding portion 42a is the first layered cladding portion, the second layered cladding portion is the layered cladding portion 42b. In this case, the mode field diameter at the wavelength of the signal light of the core portion 11f arranged in the layered cladding portion 42a is larger than the mode field diameter at the wavelength of the signal light of the core portions 11g arranged in the layered cladding portion 42b, by 10% or more and 20% or less. The effect of reducing the gain difference by the mode field diameter difference is thereby obtained well.

As described above, the multi-core optical amplifying fiber 40 according to the fourth embodiment enables reduction in the difference between the first gain and the second gain. For example, the difference is less than 0.9 dB in a case where the pumping light has a wavelength of 975 nm and power of 17 W, the signal light has a wavelength of 1550 nm and -5.0 dBm, and a gain of 18 dB is set to be obtained in each core portion. However, the gain difference is more preferably 0.5 dB or less and even more preferably 0.3 dB or less.

In this embodiment, the core diameters and the mode field diameters of the core portions 11h and 11i are equal, but the core portions 11h at a smaller distance from the central axis X may have a larger core diameter and a larger mode field diameter and the core portions 11i farther therefrom may have a smaller core diameter and a smaller mode field diameter.

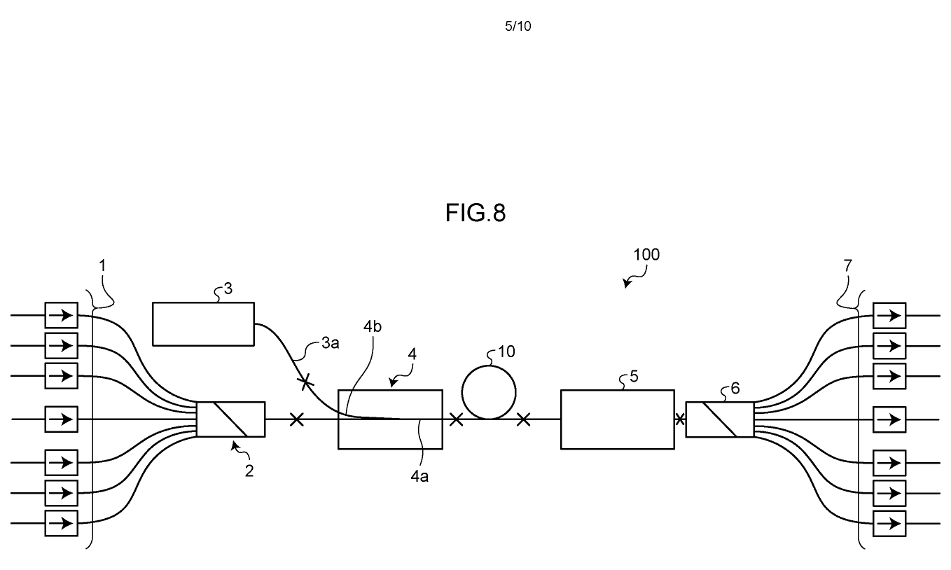

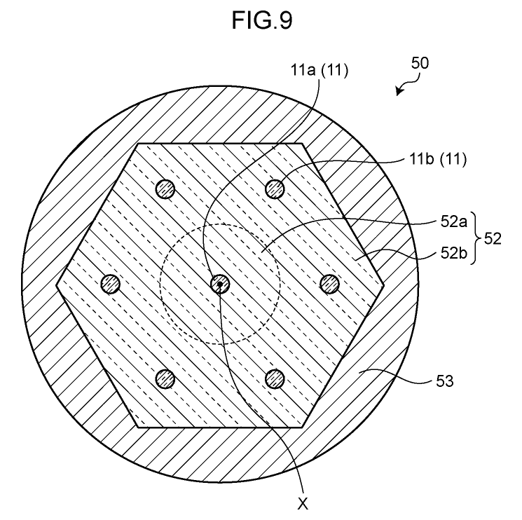

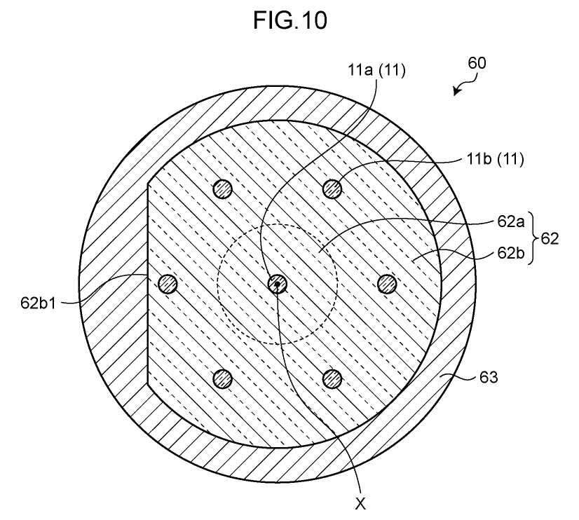

FIG. 8 is a diagram of a schematic configuration of an optical amplifier according to a fifth embodiment. An optical amplifier 100 includes seven optical isolators 1, an optical fiber fan-in 2, a pumping light source 3, an optical coupler 4, the multi-core optical amplifying fiber 10 according to the first embodiment, a pump stripper 5, an optical fiber fan-out 6, and seven optical isolators 7. The symbol, "×", in FIG. 8 represents fusion splicing points of optical fibers.

The optical fiber fan-in 2 includes seven single-mode optical fibers bundled together at one end thereof, and one multi-core fiber having seven core portions. Core portions at the bundled end of the seven single-mode optical fibers are optically coupled respectively to the core portions of the multi-core fiber. In this multi-core fiber, the core portions are arranged in a triangular lattice similarly to the core portions 11 of the multi-core optical amplifying fiber 10 illustrated in FIG. 1. Furthermore, the seven single-mode optical fibers are standard single-mode optical fibers defined by ITU-T (International Telecommunication Union) G.652, for example, and respectively have the optical isolators 1 provided therefor. The optical isolators 1 and 7 pass light in directions indicated by arrows and block passage of light in the opposite directions. The core portions of the multi-core fiber of the optical fiber fan-in 2 are respectively connected to core portions of a multi-core fiber 4a of the optical coupler 4. The core portions in the multi-core fiber 4a are arranged in a triangular lattice, similarly to the core portions 11 of the multi-core optical amplifying fiber 10 illustrated in FIG. 1. In the optical fiber fan-in, end faces at the bundled end of the seven single-mode optical fibers and an optically coupled end face of the multi-core fiber have been processed to be inclined with respect to an optical axis for reducing reflection, but they may be perpendicular to the optical axis.

When signal light is input to the single-mode optical fibers of the optical fiber fan-in 2, the optical isolators 1 respectively pass the signal light therethrough. The core portions of the multi-core fiber respectively let the signal light propagate therethrough and output the signal light to the connected core portions in the multi-core fiber 4a. The core portions of the multi-core fiber 4a let the input signal light propagate therethrough.

The pumping light source 3 outputs pumping light. The pumping light has a wavelength of 975 nm, which is approximately the same as the wavelength of the absorption peak of erbium ions in the 900 nm wavelength band. Therefore, the pumping light enables erbium ions to be optically pumped. Optical coupling optical fibers 3a and 4b let the pumping light output from the pumping light source 3 propagate therethrough. As described above, the pumping light is coupled to an inner cladding portion of the multi-core fiber 4a in the optical coupler 4 after propagating through the optical coupling optical fiber 4b, and propagates through the inner cladding portion.

The core portions 11 of the multi-core optical amplifying fiber 10 are optically connected respectively to the core portions of the multi-core fiber 4a in the optical coupler 4. Furthermore, the inner cladding portion 12 of the multi-core optical amplifying fiber 10 is optically connected to the inner cladding portion of the multi-core fiber 4a. Therefore, upon input of each signal light and pumping light that have propagated through the multi-core fiber 4a to the multi-core optical amplifying fiber 10, the signal light and the pumping light respectively propagate through the core portions 11 and the inner cladding portion 12 in the same direction. The pumping light optically pumps erbium in the core portions 11 while propagating through the inner cladding portion 12. Each signal light propagating through the core portions 11 is optically amplified by the stimulated emission effect of erbium. The multi-core optical amplifying fiber 10 outputs each signal light that has been optically amplified and pumping light that has not contributed to the optical amplification.

The pump stripper 5 is a publicly known device that passes each signal light output from the multi-core optical amplifying fiber 10 and eliminates the pumping light. For example, the pump stripper 5 has a configuration, in which part of outer cladding of a double-cladding multi-core fiber having seven core portions arranged in a triangular lattice has been removed, pumping light is taken out from a surface of an inner cladding portion at a portion corresponding to the part that has been removed, the pumping light is emitted to and absorbed by a radiator plate, and energy of the pumping light is thereby converted to heat energy and radiated. The pump stripper 5 allows each signal light to pass through the multi-core fiber and reduces the pumping light to a power level low enough not to cause any problems when the pumping light is output from the optical amplifier 100.

Similarly to the optical fiber fan-in 2, the optical fiber fan-out 6 includes seven single-mode optical fibers bundled at one end thereof and one multi-core fiber having seven core portions arranged in a triangular lattice, and is configured such that core portions at the bundled end of the seven single-mode optical fibers are optically coupled respectively to core portions of the multi-core fiber. The single-mode optical fibers respectively have the optical isolators 7 provided therefor. The multi-core fiber is connected to the pump stripper 5. End faces at the bundled end of the seven single-mode optical fibers and an optically coupled end face of the multi-core fiber have been processed to be inclined with respect to the optical axis for reducing reflection, but they may be perpendicular to the optical axis.

When the signal light is input to the core portions of the optical fiber fan-out 6 respectively from the core portions of the multi-core fiber of the pump stripper 5, the signal light propagates through the core portions of the single-mode optical fibers respectively and is output through the optical isolators 7.

The optical amplifier 100 configured as described above includes the multi-core optical amplifying fiber 10 having a small gain difference between the plurality of core portions 11 and thus enable reduction in the gain difference applied to the plurality of signal light beams that are input.

FIG. 9 is a schematic sectional view of a multi-core optical amplifying fiber according to a sixth embodiment and illustrates a cross section of the multi-core optical amplifying fiber, the cross section being perpendicular to a longitudinal direction of the multi-core optical amplifying fiber. A multi-core optical amplifying fiber 50 is a double-cladding seven-core multi-core optical fiber having a configuration of the multi-core optical amplifying fiber 10 illustrated in FIG. 1, with the inner cladding portion 12 and the outer cladding portion 13 respectively replaced by an inner cladding portion 52 and an outer cladding portion 53.

The inner cladding portion 52 is made of glass, such as silica-based glass. The inner cladding portion 52 has a hexagonal cross section. The inner cladding portion 52 has layered cladding portions 52a and 52b as a plurality of layered cladding portions that have been formed concentrically. The layered cladding portion 52a is a portion having a circular cross section with a central axis that is substantially the same as the central axis X. The layered cladding portion 52b is an annular portion having a hexagonal cross-section surrounding the outer periphery of the layered cladding portion 52a. The layered cladding portion 52a surrounds the core portion 11a and the layered cladding portion 52b surrounds the core portions 11b. That is, one or more core portions of the core portions 11 is/are arranged in each of the layered cladding portions 52a and 52b. The inner cladding portion 52 is an example of an inner cladding portion having a polygonal cross section in a plane perpendicular to the longitudinal direction.

The inner cladding portion 52 has a refractive index lower than the maximum refractive index of each of the core portions 11. Similarly to the inner cladding portion 12 illustrated in FIG. 1, the inner cladding portion 52 has a refractive index profile of the GI type. As a result, the layered cladding portion 52a has a refractive index higher than a refractive index of the layered cladding portion 52b. Furthermore, the refractive index of the inner cladding portion 52 near the core portion 11a is higher than the refractive index of the inner cladding portion 52 near the core portions 11b.

The outer cladding portion 53 is made of, for example, resin. The resin is, for example, publicly known resin that is used as resin cladding portions of double-cladding optical fibers.

In the multi-core optical amplifying fiber 50 configured as described above also, the difference between the gain in the core portion 11a and the gain in the core portions 11b becomes small due to the effect of the GI-type refractive index profile of the inner cladding portion 52 and the effect of the mode field diameter difference between the core portion 11a and the core portions 11b.

Furthermore, by the inner cladding portion 52 having the hexagonal cross section in the multi-core optical amplifying fiber 50, pumping light propagating through the inner cladding portion 52 is distributed such that its power density becomes higher nearer to the central axis X. As a result, the difference between the gain in the core portion 11a and the gain in the core portions 11b becomes even smaller. For example, the difference is less than 0.9 dB in a case where the pumping light has a wavelength of 975 nm and power of 17 W, the signal light has a wavelength of 1550 nm and -5.0 dBm, and a gain of 18 dB is set to be obtained in each core portion. However, the gain difference is more preferably 0.5 dB or less and even more preferably 0.3 dB or less.

FIG. 10 is a schematic sectional view of a multi-core optical amplifying fiber according to a seventh embodiment and illustrates a cross section of the multi-core optical amplifying fiber, the cross section being perpendicular to a longitudinal direction of the multi-core optical amplifying fiber. A multi-core optical amplifying fiber 60 is a double-cladding seven-core multi-core optical fiber having a configuration of the multi-core optical amplifying fiber 10 illustrated in FIG. 1, with the inner cladding portion 12 and the outer cladding portion 13 respectively replaced by an inner cladding portion 62 and an outer cladding portion 63.

The inner cladding portion 62 is made of glass, such as silica-based glass. The inner cladding portion 62 has a cross section having a D-shape composed of an arc and a straight line. Specifically, the inner cladding portion 62 has layered cladding portions 62a and 62b as a plurality of layered cladding portions that have been formed concentrically. The layered cladding portion 62a is a portion having a circular cross section with a central axis that is substantially the same as the central axis X. The layered cladding portion 62b is an annular portion surrounding the outer periphery of the layered cladding portion 62a, but because part of its outer periphery has a plane 62b1, the layered cladding portion 62b has a cross section having a D-shape including an arc and a straight line. The layered cladding portion 62a surrounds the core portion 11a and the layered cladding portion 62b surrounds the core portions 11b. That is, one or more core portions of the core portions 11 is/are arranged in each of the layered cladding portions 62a and 62b. The inner cladding portion 62 is an example of an inner cladding portion that has a cross section having a shape composed of an arc and a straight line, the cross section being in a plane perpendicular to the longitudinal direction.

The inner cladding portion 62 has a refractive index lower than the maximum refractive index of each of the core portions 11. Similarly to the inner cladding portion 12 illustrated in FIG. 1, the inner cladding portion 62 has a refractive index profile of the GI type. As a result, the layered cladding portion 62a has a refractive index higher than a refractive index of the layered cladding portion 62b. Furthermore, the refractive index of the inner cladding portion 62 near the core portion 11a is higher than the refractive index of the inner cladding portion 62 near the core portions 11b.

The outer cladding portion 63 is made of, for example, resin. The resin is, for example, publicly known resin that is used as resin cladding portions of double-cladding optical fibers.

In the multi-core optical amplifying fiber 60 configured as described above also, the difference between the gain in the core portion 11a and the gain in the core portions 11b becomes small due to the effect of the GI-type refractive index profile of the inner cladding portion 62 and the effect of the mode field diameter difference between the core portion 11a and the core portions 11b.

Furthermore, by the inner cladding portion 62 having the D-shaped cross section in the multi-core optical amplifying fiber 60, pumping light propagating through the inner cladding portion 62 is distributed such that its power density becomes higher nearer to the central axis X. As a result, the difference between the gain in the core portion 11a and the gain in the core portions 11b becomes even smaller. For example, the difference is less than 0.9 dB in a case where the pumping light has a wavelength of 975 nm and power of 17 W, the signal light has a wavelength of 1550 nm and -5.0 dBm, and a gain of 18 dB is set to be obtained in each core portion. However, the gain difference is more preferably 0.5 dB or less and even more preferably 0.3 dB or less.

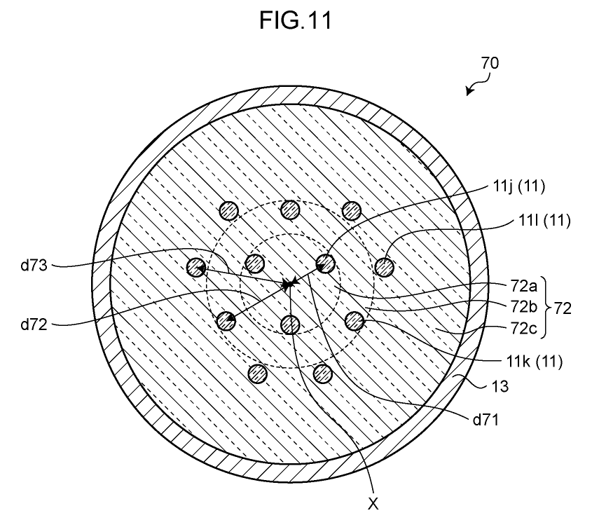

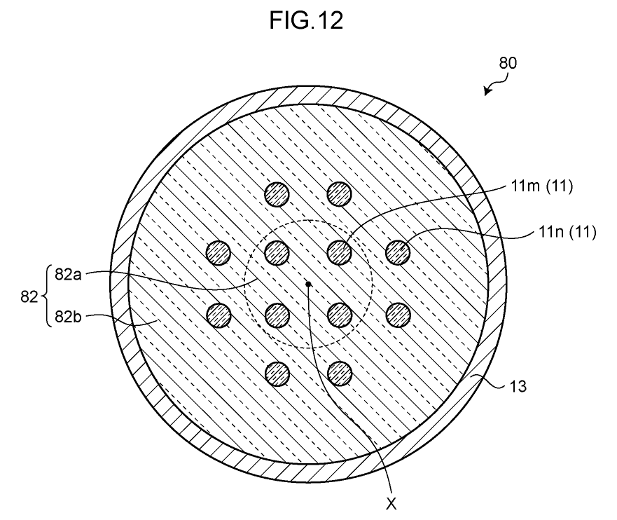

FIG. 11 is a schematic sectional view of a multi-core optical amplifying fiber according to an eighth embodiment and illustrates a cross section of the multi-core optical amplifying fiber, the cross section being perpendicular to a longitudinal direction of the multi-core optical amplifying fiber. A multi-core optical amplifying fiber 90 is a double-cladding twelve-core multi-core optical fiber having a configuration of the multi-core optical amplifying fiber 10 illustrated in FIG. 1, with the number of core portions 11 changed to twelve and the inner cladding portion 12 replaced by an inner cladding portion 72.

The core portions 11 are arranged in a triangular lattice to be in a close-packed state. Three core portions 11j of the core portions 11 are arranged to be at positions of the vertices of an equilateral triangle around the central axis X extending along the longitudinal direction in the inner cladding portion 72. Three core portions 11k of the core portions 11 are arranged to be at positions of the vertices of an equilateral triangle around the central axis X. Six core portions 11l of the core portions 11 are arranged to be at positions of the vertices of a hexagon around the central axis X.

The inner cladding portion 72 is made of glass, such as silica-based glass. The inner cladding portion 72 has layered cladding portions 72a, 72b, and 72c as a plurality of layered cladding portions that have been formed concentrically. The layered cladding portion 72a is a portion having a circular cross section with a central axis that is substantially the same as the central axis X. The layered cladding portion 72b is a portion having an annular cross section surrounding the outer periphery of the layered cladding portion 72a. The layered cladding portion 72c is a portion having an annular cross section surrounding the outer periphery of the layered cladding portion 72b. The layered cladding portion 72a surrounds the core portions 11j, the layered cladding portion 72b surrounds the core portions 11k, and the layered cladding portion 72c surrounds the core portions 11l. That is, one or more core portions of the core portions 11 is/are arranged in each of the layered cladding portions 72a, 72b, and 72c.

The inner cladding portion 72 has a refractive index lower than the maximum refractive index of each of the core portions 11. Similarly to the inner cladding portion 12 illustrated in FIG. 1, the inner cladding portion 72 has a refractive index profile of the GI type. As a result, the layered cladding portion 72a has a refractive index higher than a refractive index of the layered cladding portion 72b. Furthermore, the refractive index of the layered cladding portion 72b is higher than a refractive index of the layered cladding portion 72c. Furthermore, the refractive index of the inner cladding portion 52 near the core portions 11j is higher than the refractive index of the inner cladding portion 52 near the core portions 11k, and the refractive index of the inner cladding portion 52 near the core portions 11k is higher than the refractive index of the inner cladding portion 52 near the core portions 11l.

In a multi-core optical amplifying fiber 70, the three core portions 11j of the core portions 11 are at a distance of d71 from the central axis X of the inner cladding portion 72. The distances of the core portions 11j from the central axis X are approximately equal. Furthermore, the three core portions 11k are at a distance of d72 from the central axis X of the inner cladding portion 72. The distances of the core portions 11k from the central axis X are approximately equal. Furthermore, the six core portions 11l are at a distance of d73 from the central axis X of the inner cladding portion 72. The distances of the core portions 11l from the central axis X are approximately equal. If any one of d71, d72, and d73 is an example of a first distance, any distance thereof longer (farther) than the first distance is an example of a second distance in relation to the first distance.

In the multi-core optical amplifying fiber 70 configured as described above also, for example, the difference between a gain in the core portions 11j and a gain in the core portions 11lbecomes small due to the effect of the GI-type refractive index profile of the inner cladding portion 72 and the effect of the mode field diameter differences between the core portions 11j, the core portions 11k, and the core portions 11l. For example, the difference is less than 0.9 dB in a case where the pumping light has a wavelength of 975 nm and power of 17 W, the signal light has a wavelength of 1550 nm and -5.0 dBm, and a gain of 18 dB is set to be obtained in each core portion. However, the gain difference is more preferably 0.5 dB or less and even more preferably 0.3 dB or less.

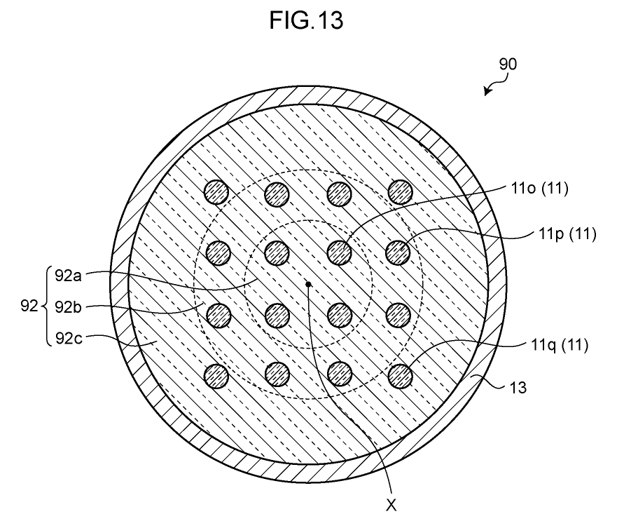

FIG. 12 is a schematic sectional view of a multi-core optical amplifying fiber according to a ninth embodiment and illustrates a cross section of the multi-core optical amplifying fiber, the cross section being perpendicular to a longitudinal direction of the multi-core optical amplifying fiber. A multi-core optical amplifying fiber 80 is a double-cladding twelve-core multi-core optical fiber having a configuration of the multi-core optical amplifying fiber 70 illustrated in FIG. 11, with the arrangement of the core portions 11 changed and the inner cladding portion 72 replaced by an inner cladding portion 82.

The core portions 11 are arranged in a square pattern. Four core portions 11m of the core portions 11 are arranged to be at positions of the vertices of a square around the central axis X extending along the longitudinal direction, in the inner cladding portion 82. Eight core portions 11k of the core portions 11 are arranged to be at positions of the vertices of an octagon around the central axis X. In this case, the core portions 11 are arranged to have n-fold rotational symmetry within the inner cladding portion, where n is 2 or 4.

The inner cladding portion 82 is made of glass, such as silica-based glass. The inner cladding portion 82 has layered cladding portions 82a and 82b as a plurality of layered cladding portions that have been formed concentrically. The layered cladding portion 82a is a portion having a circular cross section with a central axis that is substantially the same as the central axis X. The layered cladding portion 82b is a portion having an annular cross section surrounding the outer periphery of the layered cladding portion 82a. The layered cladding portion 82a surrounds the core portions 11m and the layered cladding portion 82b surrounds the core portions 11n. That is, one or more core portions of the core portions 11 is/are arranged in each of the layered cladding portions 82a and 82b.

The inner cladding portion 82 has a refractive index lower than the maximum refractive index of each of the core portions 11. Similarly to the inner cladding portion 12 illustrated in FIG. 1, the inner cladding portion 82 has a refractive index profile of the GI type. As a result, the layered cladding portion 82a has a refractive index higher than a refractive index of the layered cladding portion 82b. Furthermore, the refractive index of the inner cladding portion 82 near the core portions 11m is higher than the refractive index of the inner cladding portion 82 near the core portions 11n.

In the multi-core optical amplifying fiber 80 configured as described above also, the difference between a gain in the core portions 11m and a gain in the core portions 11n becomes small due to the effect of the GI-type refractive index profile of the inner cladding portion 82 and the effect of the mode field diameter difference between the core portions 11m and the core portions 11n. For example, the difference is less than 0.9 dB in a case where the pumping light has a wavelength of 975 nm and power of 17 W, the signal light has a wavelength of 1550 nm and -5.0 dBm, and a gain of 18 dB is set to be obtained in each core portion. However, the gain difference is more preferably 0.5 dB or less and even more preferably 0.3 dB or less.

FIG. 13 is a schematic sectional view of a multi-core optical amplifying fiber according to a tenth embodiment and illustrates a cross section of the multi-core optical amplifying fiber, the cross section being perpendicular to a longitudinal direction of the multi-core optical amplifying fiber. A multi-core optical amplifying fiber 90 is a double-cladding 16-core multi-core optical fiber having a configuration of the multi-core optical amplifying fiber 80 illustrated in FIG. 12, with the number of core portions 11 changed to 16 and the inner cladding portion 82 replaced by an inner cladding portion 92.

The core portions 11 are arranged in a square pattern. Four core portions 11o of the core portions 11 are arranged to be at positions of the vertices of a square around the central axis X extending along the longitudinal direction in the inner cladding portion 92. Eight core portions 11p of the core portions 11 are arranged to be at positions of the vertices of an octagon around the central axis X. Four core portions 11q of the core portions 11 are arranged to be at positions of the vertices of a square around the central axis X.

The inner cladding portion 92 is made of glass, such as silica-based glass. The inner cladding portion 92 has layered cladding portions 92a, 92b, and 92c as a plurality of layered cladding portions that have been formed concentrically. The layered cladding portion 92a is a portion having a circular cross section with a central axis that is substantially the same as the central axis X. The layered cladding portion 92b is a portion having an annular cross section surrounding the outer periphery of the layered cladding portion 92a. The layered cladding portion 92c is a portion having an annular cross section surrounding the outer periphery of the layered cladding portion 92b. The layered cladding portion 92a surrounds the core portions 11o, the layered cladding portion 92b surrounds the core portions 11p, and the layered cladding portion 92c surrounds the core portions 11q. That is, one or more core portions of the core portions 11 is/are arranged in each of the layered cladding portions 92a, 92b, and 92c.

The inner cladding portion 92 has a refractive index lower than the maximum refractive index of each of the core portions 11. Similarly to the inner cladding portion 12 illustrated in FIG. 1, the inner cladding portion 92 has a refractive index profile of the GI type. As a result, the layered cladding portion 92a has a refractive index higher than a refractive index of the layered cladding portion 92b. Furthermore, the refractive index of the layered cladding portion 92b is higher than a refractive index of the layered cladding portion 92c. Furthermore, the refractive index of the inner cladding portion 92 near the core portions 11o is higher than the refractive index of the inner cladding portion 92 near the core portions 11p, and the refractive index of the inner cladding portion 92 near the core portions 11p is higher than the refractive index of the inner cladding portion 92 near the core portions 11q.

In the multi-core optical amplifying fiber 90 configured as described above also, for example, the difference between a gain in the core portions 11o and a gain in the core portions 11q becomes small due to the effect of the GI-type refractive index profile of the inner cladding portion 92 and the effect of the mode field diameter differences between the core portions 11o, the core portions 11p, and the core portions 11q. For example, the difference is less than 0.9 dB in a case where the pumping light has a wavelength of 975 nm and power of 17 W, the signal light has a wavelength of 1550 nm and -5.0 dBm, and a gain of 18 dB is set to be obtained in each core portion. However, the gain difference is more preferably 0.5 dB or less and even more preferably 0.3 dB or less.

In the above described embodiments, the number of core portions in the multi-core optical amplifying fiber is 7, 12, 16, or 19, but the number of core portions is not particularly limited. Furthermore, the core portions are not necessarily arranged in a triangular lattice or a square lattice. Furthermore, in the above described embodiments, the optical amplifying medium in the multi-core optical amplifying fiber is erbium, but may be any other optical amplifying medium, such as ytterbium (Yb), thulium (Tm), or praseodymium (Pr). The wavelength of the pumping light may be set as appropriate to a wavelength that allows the optical amplifying medium to be optically pumped.

Furthermore, in the above described embodiments, each of the core portions of the multi-core optical amplifying fiber is configured to let signal light propagate therethrough in a single mode, but may be configured to let signal light propagate therethrough in a multimode manner.

Furthermore, in the above described embodiments, the plurality of core portions are arranged to have n-fold rotational symmetry within the inner cladding portion, where n is 2 ,3, 4, or 6, but n may be another integer equal to or greater than 2. For example, another integer is 5, 8, 9, 10, 12, or 16.

Furthermore, in the above described embodiments, the core portions are each arranged to not extend across two layered cladding portions, but may each be arranged to extend across the boundary between two layered cladding portions.

Furthermore, in the above described embodiments, there is one pumping light source and one optically coupling optical fiber in the optical coupler, but there may be a plurality of pumping light sources and a plurality of optical coupling optical fibers in the optical coupler. Furthermore, in the above described embodiments, the optical amplifier is of the forward pumping type, but may be of the backward pumping type or the bidirectional pumping type. To form the backward pumping type optical amplifier, the optical coupler 4 may be connected to an end of the multi-core optical amplifying fiber 10, the end being toward the optical fiber fan-out 6, and the pump stripper 5 may be connected to an end of the multi-core optical amplifying fiber 10, the end being toward the optical fiber fan-in 2. Furthermore, in a case where power of pumping light that is output from the multi-core optical amplifying fiber 10 and has not contributed to optical amplification is comparatively low, the pump stripper 5 may be not provided.

Furthermore, the present disclosure is not to be limited by the above described embodiments. Those configured by combining the components described above as appropriate are also included in the present disclosure. For example, of the above described embodiments, in any embodiment, in which the inner cladding portion has a refractive-index profile of the GI type, the refractive index profile may be replaced by that of the stepped type. In addition, further effects and modified examples may be easily derived by those skilled in the art. Therefore, wider aspects of the present disclosure are not limited to the above described embodiments, and various modifications are possible.

The present disclosure may be utilized in optical amplifying fibers, optical fiber amplifiers, and optical communication systems.

The present disclosure enables implementation of a multi-core optical amplifying fiber that enables reduction of differences in gain between a plurality of core portions, and an optical fiber using the multi-core optical amplifying fiber.

What is claimed is:

1. A multi-core optical amplifying fiber, comprising:
a plurality of core portions doped with a rare earth element;
an inner cladding portion surrounding the plurality of core portions and having a refractive index lower than a maximum refractive index of each of the core portions; and
an outer cladding portion surrounding the inner cladding portion and having a refractive index lower than the refractive index of the inner cladding portion, wherein
the plurality of core portions include a first core portion at a first distance that is a distance from a central axis of the inner cladding portion extending along a longitudinal direction, and a second core portion at a second distance that is a distance from the central axis and longer than the first distance, and
in a case where pumping light that optically pumps the rare earth element and has predetermined power is caused to propagate through the inner cladding portion and signal light that is optically amplified by the rare earth element is caused to propagate through each of the first core portion and the second core portion, a difference between a first gain obtained by the signal light in the first core portion and a second gain obtained by the signal light in the second core portion is less than 0.9 dB.

2. The multi-core optical amplifying fiber according to claim 1, wherein a first refractive index that is a refractive index of the inner cladding portion near the first core portion is higher than a second refractive index that is a refractive index of the inner cladding portion near the second core portion.

3. The multi-core optical amplifying fiber according to claim 1, wherein a refractive index of a central region including the central axis of the inner cladding portion is higher than a refractive index of a peripheral region surrounding the central region of the inner cladding portion.

4. The multi-core optical amplifying fiber according to claim 3, wherein the inner cladding portion has a GI-type refractive index profile.

5. The multi-core optical amplifying fiber according to claim 3, wherein the inner cladding portion has a stepped refractive index profile.

6. The multi-core optical amplifying fiber according to claim 3, wherein a cross section of the inner cladding portion has a circular shape, a polygonal shape, or a shape composed of an arc and a straight line, the cross section being in a plane perpendicular to the longitudinal direction.

7. The multi-core optical amplifying fiber according to claim 1, wherein a first mode field diameter that is a mode field diameter of the first core portion at a wavelength of the signal light is larger than a second mode field diameter that is a mode field diameter of the second core portion at the wavelength of the signal light.

8. The multi-core optical amplifying fiber according to claim 1, wherein the plurality of core portions are arranged to have n-fold rotational symmetry within the inner cladding portion, where n is an integer equal to or greater than 2.

9. The multi-core optical amplifying fiber according to claim 1, wherein
the inner cladding portion includes a plurality of layered cladding portions formed concentrically, and
one or more core portions of the plurality of core portions are arranged in each of the plurality of layered cladding portions.

10. The multi-core optical amplifying fiber according to claim 9, wherein a mode field diameter of the core portion or core portions arranged in a first layered cladding portion of the plurality of layered cladding portions is larger than a mode field diameter of the core portion or core portions arranged in a second layered cladding portion outside and adjacent to the first layered cladding portion by 10% or more and 20% or less, the mode field diameters being at a/the wavelength of the signal light.

11. An optical amplifier, comprising:
the multi-core optical amplifying fiber according to claim 1;
a pumping light source configured to output pumping light to optically pump the rare earth element in the multi-core optical amplifying fiber; and
an optical coupler configured to optically couple the pumping light to the inner cladding portion.
